(19) United States
(12) Patent Application Publication
(10) Pub. No.: US 2023/0408289 A1
(43) Pub. Date: Dec. 21, 2023

(54) GUIDANCE OF A TRANSPORT VEHICLE TO A LOADING POINT

(71) Applicant: CEPTION TECHNOLOGIES LTD., Jerusalem (IL)

(72) Inventors: Yossef Israel BUDA, Kfar-Adumim (IL); Tal ISRAEL, Mazkeret-Batya (IL)

(73) Assignee: CEPTION TECHNOLOGIES LTD., Jerusalem (IL)

(21) Appl. No.: 18/017,851

(22) PCT Filed: Jul. 28, 2021
(86) PCT No.: PCT/IL2021/050907

§ 371 Date: Jan. 24, 2023

Related U.S. Application Data
(60) Provisional application No. 63/057,337, filed on Jul. 28, 2020.

(51) Int. Cl. G01C 21/00; B60W 60/00

(52) U.S. Cl. CPC G01C 21/3811; G01C 21/3837; B60W 60/0025; B60W 2556/40; B60W 2556/45; B60W 2420/42; B60W 30/09

(57) ABSTRACT

A vehicle onboard guidance system includes a guidance unit having a communications module. A processor is configured to receive from one or more sensors sensed data of at least a topography of an environment of a vehicle on which the guidance unit is installed. The sensed data is analyzed to generate a map of the environment based on the received sensed data and share, via the communications module, the generated map with another vehicle onboard guidance system, to register the topography with a map of the environment that was received, via the communications module, from another vehicle onboard guidance system, or to modify a map that was received from another vehicle onboard guidance system.

### FIELD OF THE INVENTION

The present invention relates to vehicle guidance. More particularly, the present invention relates to guidance of a transport vehicle to a loading point.

### BACKGROUND OF THE INVENTION

Mining and construction operations typically include excavation either to remove material for use (e.g., a material that is to be mined), or waste material (e.g., layers that cover deposits of a material to be mined or that are to be excavated in order to lay foundations for construction), or other materials. Typically, the removed or collected materials are loaded into dump trucks or other transport vehicles using mining shovels, excavators, or other types of power shovels or equipment. The removed material is then transported to a pit or other location where the material is dumped.

Typically, a transport vehicle approaches to point where the material is to be loaded onto the vehicle while travelling backward.

The removal of material may often create a productivity bottleneck. Thus, if removal of material from is delayed, subsequent mining or construction operations may be further delayed.

### SUMMARY OF THE INVENTION

There is thus provided, in accordance with an embodiment of the invention, a vehicle onboard guidance system including: a guidance unit including: a communications module; and a processor configured to: receive from one or more sensors sensed data of at least a topography of an environment of a vehicle on which the guidance unit is installed; analyze the sensed data to perform one or more of: generate a map of the environment based on the received sensed data and share, via the communications module, the generated map with another vehicle onboard guidance system; register the topography with a map of the environment that was received, via the communications module, from another vehicle onboard guidance system; and generate an updated map by modifying a map of the environment that was received, via the communications module, from another vehicle onboard guidance system.

Furthermore, in accordance with an embodiment of the invention, the processor is further configured to calculate, based on the map, a route of a transport vehicle to a loading point where a load is to be loaded onto the transport vehicle by a loader.

Furthermore, in accordance with an embodiment of the invention, the vehicle on which the guidance unit is installed is the transport vehicle or the loader.

Furthermore, in accordance with an embodiment of the invention, the calculated route includes an approach direction of the transport vehicle to the loading point.

Furthermore, in accordance with an embodiment of the invention, the processor is further configured to guide the transport vehicle along the calculated route to the loading point.

Furthermore, in accordance with an embodiment of the invention, the processor is configured to guide the transport vehicle by communicating with a control system that is configured to autonomously control the transport vehicle.

Furthermore, in accordance with an embodiment of the invention, the system includes the one or more sensors. Furthermore, in accordance with an embodiment of the invention, the one or more sensors is configured to sense a marker that marks the location of a loading point where a load is to be loaded onto the transport vehicle by a loader.

Furthermore, in accordance with an embodiment of the invention, the mark includes a beam that is projected by the loader onto the loading point.

Furthermore, in accordance with an embodiment of the invention, the beam includes infrared radiation.

Furthermore, in accordance with an embodiment of the invention, the one or more sensors includes an imaging sensor.

Furthermore, in accordance with an embodiment of the invention, the processor is configured to identify an image of the loader and a position of the loading point relative to the loader in an image that is acquired by the imaging sensor.

Furthermore, in accordance with an embodiment of the invention, the processor is configured to share, via the communications module, the updated map with another vehicle onboard guidance system.

There is further provided, in accordance with an embodiment of the invention, a guidance method including: receiving, by a processor of a vehicle onboard guidance system from one or more sensors, sensed data of at least a topography of an environment of a vehicle on which the guidance unit is installed; analyzing, by the processor, the sensed data to perform one or both of: generating a map of the environment based on the received sensed data and share, via the communication module, the generated map with another vehicle onboard guidance system; and registering the topography with a map of the environment that was received, via the communication module, from another vehicle onboard guidance system.

Furthermore, in accordance with an embodiment of the invention, the method includes calculating by the processor, based on the map, a route of a transport vehicle to a loading point where a load is to be loaded onto the transport vehicle by a loader.

Furthermore, in accordance with an embodiment of the invention, the processor that calculates the route is installed on the transport vehicle or on the loader.

Furthermore, in accordance with an embodiment of the invention, the method includes guiding the transport vehicle to the loading point.

Furthermore, in accordance with an embodiment of the invention, the method includes identifying, by the processor, an obstacle.

Furthermore, in accordance with an embodiment of the invention, calculating the route includes calculating a route that avoids the obstacle.

Furthermore, in accordance with an embodiment of the invention, guiding the transport vehicle includes transmitting the calculated route to a control system that is configured to autonomously operate the transport vehicle.

Furthermore, in accordance with an embodiment of the invention, guiding the transport vehicle includes operating a user interface to convey instructions for travelling along the calculated route to an operator of the transport vehicle.

There is further provided, in accordance with an embodiment of the invention, a method including: providing to each of a plurality of vehicles operating at a site a vehicle onboard guidance system including: a guidance unit including: a communication module; and a processor configured to: receive from one or more sensors sensed data of at least a topography of an environment of a vehicle on which the guidance unit is installed; analyze the sensed data to perform one or more of: generate a map of the environment based on the received sensed data and share, via the communication module, the generated map with another vehicle onboard guidance system; register the topography with a map of the environment that was received, via the communication module, from another vehicle onboard guidance system; and generate an updated map by modifying a map of the environment that was received, via the communications module, from another vehicle onboard guidance system.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1A schematically illustrates components of a guidance system, in accordance with an embodiment of the invention.

FIG. 1B is a schematic block diagram of an example of a vehicle unit of the guidance system illustrated in FIG. 1A.

FIG. 1C is a schematic block diagram of a loader unit of the guidance system illustrated in FIG. 1A.

FIG. 2 is a schematic block diagram illustration an example of operation of the guidance system illustrated in FIG. 1A that is associated with a transport vehicle.

FIG. 3 is a flow chart depicting a method of operation of the guidance system illustrated in FIG. 1A.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the invention, a location-based guidance system that provides real time map sharing that is utilized to guide or otherwise facilitate motion of a transport vehicle to a location, referred to herein as a loading point, where a load, typically a material, is to be loaded onto the transport vehicle by a loader. Typically, a plurality of transport vehicles are active in a site (e.g., a mining or construction site) in which the guidance system operates. Preferably, all of the transport vehicles that operate at the site, as well as all loaders at the site, are connected to the guidance system.

A transport vehicle typically travels between one or more loading points and one or more unloading points. A load of material that was loaded onto the transport vehicle at a loading point may be unloaded from the transport vehicle at an unloading point. After the material is unloaded, the transport vehicle typically returns to the same or a different loading point.

A typical transport vehicle may include a dump truck, or any other self-propelled vehicle onto which material for transport may be loaded and that is capable of travelling in two dimensions over a surface (e.g., and is not confined to travelling along a previously installed track, rail, wire, or other guiding structure). In some examples, a transport vehicle may be autonomous (e.g., self-driving or robotic) or semiautonomous (e.g., including one or more mechanisms for assisting a human driver in some task of operation of the transport vehicle). When the transport vehicle is autonomous or semiautonomous, the guidance system may automatically control the transport vehicle to travel to the loading point. After the load is loaded onto the transport vehicle by the loader, the transport vehicle may transport the load to an unloading point where the material is to be unloaded from the transport vehicle. For example, the unloading point may include a site where waste material is to dumped, a storage facility where a mined material is to be unloaded for later use, or another site where the material is to be unloaded.

A typical loader is in the form of an excavator, power shovel, e.g., a mining shovel, or other loading vehicle whose location may be moved between times when the transport vehicle is loaded. In some cases, the loader may operate autonomously or semiautonomously. Typically, the loading point is located at a location that is fixed relative to the loader (e.g., at a location of a component, e.g., a bucket or digger, of the loader that is operated to place material onto the transport vehicle).

The guidance system includes individual vehicle onboard guidance systems that are installed on a plurality of vehicles that cooperate with the guidance system, e.g., on transport vehicles, loaders, or both. Typically, each vehicle onboard guidance system includes a guidance unit that is installed on each vehicle, e.g., one or more transport vehicles or loaders. The guidance unit may include or communicate with a set of one or more sensors that sense data that are indicative of a topography of the environment of the vehicle (and possibly other characteristics of the environment, or of the location of the vehicle). Each guidance unit includes a processor (which may be remote) and a communications module for communicating with the communications modules of other guidance units that are installed on other vehicles.

The guidance system is configured to utilize information gathered by sensors on one or more of the various vehicles, e.g., transport vehicles and loaders, to create and continually update a map that indicates the loading and unloading points, and that indicates the current location and orientation of each transport vehicle (e.g., relative to a loader or otherwise, e.g., relative to a local or global reference system). For example, the guidance unit may compare sensor data with a map that is received from another vehicle and registered sensed features with features on the map. In some cases, e.g., where various sensed features are identifiable and their locations are known (e.g., in a local or global coordinate system), the guidance unit may use the registration of the sensor date with the map to fix a location of the vehicle relative to a local or global coordinate system. The guidance system is configured to create the map by using resources (referred to herein collectively as units, or more specifically as vehicle or loader units) that are installed on (e.g., mounted on or built into) one or more vehicles (e.g., transport vehicles or loaders) that operate at a site in which the guidance system operates. The map and other information is shared among the various vehicles.

A vehicle unit is installed on one or more transport vehicles that cooperate with the guidance system. Some components of the vehicle unit may be installed in the transport vehicle specifically for the purpose of operation of the guidance system. Some components of the vehicle unit may be standard equipment of the transport vehicle and may be configured to communicate with other components of the vehicle unit.

The vehicle unit include sensors, which may include one or more types of navigation devices or navigation aids. Navigation devices and aids may include one or more cameras or optical imaging devices. For example, the cameras may be configured to image visible light or another spectral range (e.g., infrared or another spectral range), and may produce a two-dimensional or three-dimensional (stereoscopic) image. Other navigation devices and aids may include lidar, ultrasound, radar, or other scannable rangefinder (e.g., based on time-of-flight measurement) and capable of creating a map of nearby surfaces (e.g., along a direct line of sight from the sensor). Navigation devices may include a receiver for a global navigation satellite system (GNSS), such as the Global Positioning System (GPS). Navigation devices and aids may include one or more orientation sensors (e.g., an inertial (gyroscopic) or magnetic compass), a tilt sensor, or other aids in determining a current orientation of the transport vehicle that is provided with the navigation aids. Other navigation devices may include proximity sensors.

The vehicle unit may include a processing unit. The processing unit may include one or more intercommunicating computers or processors that are configured to operate in accordance with programmed instructions. Processors of the processing unit may include one or more processors that are installed specifically as part of the guidance system, onboard computers that are built into the transport vehicle, or a processor (e.g., of a smartphone) that is associated with a driver or operator of the transport vehicle.

The processing unit communicates with one or more data storage units of the vehicle unit. The data storage unit may be utilized to store programmed instructions for operation of the processing unit, data sensor data and data received from other vehicles for use by the processing unit in performing calculations, and results of calculations including a map that is created by the guidance system.

The vehicle unit includes a communications unit to enable wireless communication between the processing unit of one transport vehicle and with the processing units of one or more other transport vehicles (or loaders) that are connected to the guidance system.

The vehicle unit includes one or more output devices to communicate data to a driver or operator of the transport vehicle to facilitate travel to the loading point. For example, the output devices may include an operator display system, e.g., including one or more display screens, warning lights, or other devices for communicating visual data to the driver or operator. The output devices may include one or more speakers or alarms for communicating verbalized or other audible information to the driver or operator.

The vehicle unit may include one or more input devices that enable the driver or operator to operate or control the vehicle unit, e.g., by inputting instructions or data.

Each loader may be provided with a loader unit that may be identical to or similar to (e.g., adapted to differences in mode or conditions of operation between a loader and a transport vehicle) a vehicle unit.

A loader unit may include, in addition to components of a vehicle unit, one or more marking devices that are configured to produce a marking to mark the loading point in a manner that may be detectable by a sensor of a vehicle unit. For example, the loader unit may include an infrared projection unit that is configure to project a beam of infrared radiation onto the ground to illuminate the loading point. The illuminated location may be detected by an infrared-sensitive camera of the vehicle unit and may be utilized by the processing unit or the vehicle unit to guide the transport vehicle to the loading point.

Where the loader unit does not include a marking device, the processing unit of the vehicle unit may be configured to analyze an image of the loader and to calculate the loading point relative to the loader. For example, the analysis may be based on examples of operation of the transport vehicle during which sensors of the vehicle unit are operated. Sensor data that is acquired during successful and unsuccessful approaches to the loading point may be analyzed, e.g., by machine learning processes, to develop a guidance algorithm for guiding the transport vehicle to the loading point. In some cases, the programming of the processing unit may include a machine-learning module to generate continual updates to the guidance algorithm.

It may be noted that several types of transport vehicles may operate at a site. Therefore, the types and placement of sensors on a transport vehicle may be different for different types of transport vehicle, and in some cases for different transport vehicles of a single type. Accordingly, a machine learning process or other calculation of an optimal route to a loading point in some cases may be specific to a particular transport vehicle or type of transport vehicle. In some cases, a processor of a vehicle unit may be configured to adapt an optimal route or guidance information that was generated for one or more different types of transport vehicle to the transport vehicle with which the vehicle unit is associated.

In some cases, the guidance system may include a system controller, e.g., at a single location or at dispersed locations. A processor of the system controller may be configured to receive and utilize data from individual vehicle units and loader units to create an overall map of the site and calculate and update routes to different loading points. A data storage unit of the system controller may be utilized to store a record of routes travelled by all of the transport vehicles of the system. The created map and any results of analysis of received data may be communicated to some or all of the vehicle units and loader units.

The guidance system may be configured to function in one or more modes. In some cases, a mode may be selected in accordance with characteristics of a particular site. For example, such characteristics may include visibility or other conditions affecting sensor reliability at the site, topographical considerations (e.g., a rate at which ground contours are changing), number of transport vehicles operating at the site, distances travelled by transport vehicles, or other considerations.

For example, a loader unit may be configured to communicate a precise location of the loading point, either relative to the loader or according to a local or global coordinate system. In another example, the location of a loading point relative to a relatively stationary loader may be predetermined, or a loader may be positioned at a precise position relative to a predetermined loading point. In another example, multiple loading points may be defined relative to the loader (e.g., where a loading component of the loader is repeatedly rotatable to a precise rotation angle). In another example, the loader unit operates a marking device (e.g., infrared projector) to mark one or more loading points.

The guidance system (e.g., processing units of one or more vehicle units or loader units) may analyzed data from sensors to detect the position of a transport vehicle relative to a loader or relative to a mapping of the surrounding region. A current path of movement of the transport vehicle relative to a calculated required path may be displayed, e.g., on a birds-eye view image or map of the site or may be superimposed onto a video image from a rearward-looking camera as the transport vehicle backs up to the loading point.

In some examples, the guidance system may be configured to learn the location of the required loading point from a recording of sensor data of a transport vehicle traveling to the loading point during a first trip under manual control of the driver. The guidance system may then analyze the recorded data. The guidance system may utilize results of the analysis such that during subsequent approaches to the same loading point, the guidance system may automatically identify the loading point guide the transport vehicle to the loading point.

In some examples, the guidance system may apply an automatic loading point calculation process that learns optimal loading points relative to the loader, the loader environment, or both. As part of the learning process, the guidance system may receive one or more of images, videos, a two-dimensional map, a three-dimensional map, loader information (e.g., one or more of type of loader, position of loader, capabilities, excavator location), transport vehicle information (e.g., type, position, capabilities), a relative position between the loader and the transport vehicle, a description of an approach trajectory, a volume of a load, and the total loading time (e.g., including approach time and actual loading time). A map may include a two-dimensional pixel map, a three-dimensional volumetric voxel map, a two-dimensional or three-dimensional point cloud map, or another type of map. During the learning process, the guidance system may analyze the map and identify the loading point using deep learning segmentation algorithms (e.g., ScanNet or Semantic3D algorithms or technology, or other algorithms or technologies). During the learning process, the guidance system may detect a transport vehicle or loader using a two-dimensional or three-dimensional detection algorithm such as a YOLO, SSASSD or 3D-CVF algorithm. A loss function (or cost function) may be defined and minimized to minimize loading time (in order to increase the productivity of the process, e.g., maximal loading volume in minimal time) by using machine or deep learning networks such FCNN or LSTM. For example, an input to the algorithm may be the final loading position, the surrounding topography (e.g., including surface contours, piles of material to be loaded), type of loader and transport vehicle, relative positions and trajectories, and other relevant data. The loss function is selected such that minimizing the loss function minimizes the loading time. The result of the learning process may be an optimal loading point relative to the loader.

An operation method of the guidance system may include generating a two- or three-dimensional map of the region that surrounds the loader. For example, a processing unit of the guidance system may apply one or more structure from motion (SfM) techniques, simultaneous localization and mapping (SLAM) techniques, or other techniques to create and continually update the map.

The operation method may include detecting the position of the transport vehicle relative to the map. Alternatively or in addition, the operation method may include detecting the position of the transport vehicle relative to an image frame acquired by a sensor of the loader unit. This may include one or more frame association or precise frame positioning methods such as a bag-of-visual-words (BoW) model, random sample consensus (RANSAC) methods, perspective-n-point (PnP) solutions, or other methods. Alternatively or in addition, the operation method may include measuring a position of the transport vehicle using a GNSS receiver relative to the position of the loader measured using the GNSS or relative to the map. Alternatively or in addition, the operation method may include detecting the loader by the vehicle unit using one or more algorithms such as creating a three-dimensional model of the loader, training via a deep learning technique using a predetermined ideal loading point relative to the loader and determining a position relative of the transport vehicle relative to that ideal loading point. Alternatively or in addition, the operation method may include identifying a position of the transport vehicle relative to a marker that is produced by a marking device of the loader unit, e.g., a projected infrared beam, a beacon mounted on the loader, or other marking.

In some cases, operation method may include recording a route that was travelled by a transport vehicle to or from the loading point. The guidance system may then guide the transport vehicle to travel along that same route when subsequently returning to the loading point.

The operation may include operating the communications units of the vehicle units of different transport vehicles to share a three dimensional map that is created by each vehicle unit or loader unit to continually update the shared map.

The operation method may include calculating an optimal route of approach of a transport vehicle to the loading point, using one or more route optimization methods. For example, route optimization may include applying techniques or algorithms such as a random tree search algorithm, an A* search algorithm with kinematic constraints, deep reinforcement learning techniques, or other techniques and algorithms known in the art that are applicable to route optimization. The guidance system may indicate the calculated optimal route of approach on a display unit of the vehicle unit, e.g., in the form of a map or otherwise. The guidance system may also indicate a current projected direction of travel of the transport vehicle based on a current steering angle, orientation, or direction of travel of the transport vehicle, e.g., as measured by sensors of the vehicle unit.

In some cases, the operation method may include recording data in a data storage unit of the vehicle unit, transmitting data to a remote system controller, e.g., for storage in a database, or uploading the data for cloud storage. The data may be utilized to improve operations, e.g., by indicating where vehicle maintenance or driver training are required.

In some cases, the operation method may include operating the transport vehicle via a control system of the transport vehicle. The operation of the transport vehicle by the guidance system may be limited approaching the loading point, or may operate the vehicle fully autonomously.

The operation method may include analyzing data from one or more sensors of the vehicle unit to detect obstacles. When the obstacle is detected, the vehicle unit may generate an alert that is visible or audible to a driver or operator of the transport vehicle. The generated map may be updated to indicate the obstacle, and to modify any calculated routes that pass near the obstacle.

A guidance system and operation method as described herein, e.g., that includes sharing of maps and data in real time between transport vehicles, may be advantageous over other types of guidance systems or methods.

The environment in which transport vehicles and loaders operate is often dusty such that vision is obscured. Furthermore, an operator of a transport vehicle may be sitting at a location from which a view of the immediate vicinity of the transport vehicle is obstructed. Often, a transport vehicle approaches a loading point while travelling in reverse, often necessitating guidance in order to efficiently and precisely position the transport vehicle at the loading point (e.g., without multiple approaches and corrections). In many cases, the topography of the site is frequently changing due to continued excavation, dumping, construction, or other factors. These factors and others may render difficult direct and accurate approach of a transport vehicle to a loading point.

When a transport vehicle has difficulty in accurately travelling to a loading point, the operator of the transport vehicle may be required to make multiple attempts to reach the loading point. In the meantime, other transport vehicles may be prevented from approaching the loading point. As a result, the process of transporting material from the loading point to an unloading point may be delayed.

A guidance system in accordance with an embodiment of the present invention may facilitate direct approach of an operator of a transport vehicle to precise location of the loading on a first attempt. The guidance system may be configured to guide transport vehicles of different types, and under various environmental conditions, to the loading point. Sharing of generated maps among transport vehicles may facilitate or expedite calculation of a precise and efficient route to the loading point. Thus, the guidance system may result in more efficient operation of the site at which the guidance system in operating.

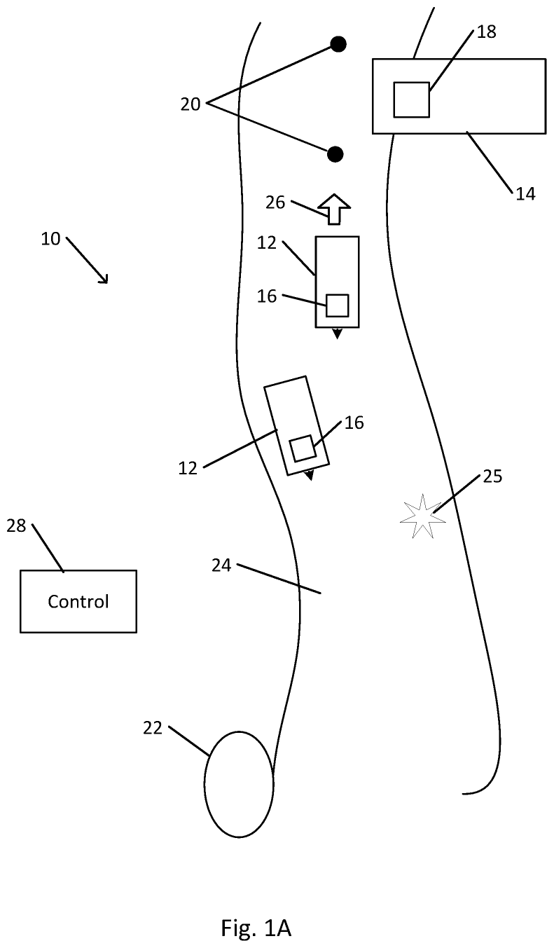

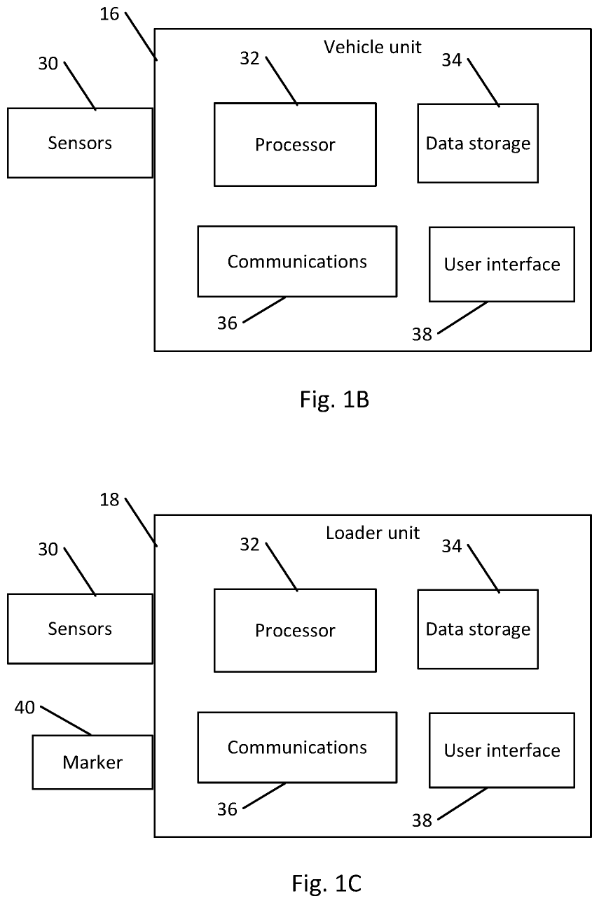

FIG. 1A schematically illustrates components of a guidance system, in accordance with an embodiment of the invention.

Guidance system 10 is configured to facilitate the travel of one or more transport vehicles 12 (e.g., a dump truck, flatbed truck, or other type of vehicle capable of transporting a material that is loaded onto the vehicle) to one or more loading points 20. Each loading point 20 is located adjacent to a loader 14 (e.g., a power shovel, excavator, crane, or other vehicle or other type of movable equipment that is capable of loading material onto a transport vehicle 12). For example, a loading point 20 may be located at a location to which a bucket, digger, shovel, or other component of loader 14 may be manipulated in order to load material onto a transport vehicle 12. In some cases, a transport vehicle 12 may approach a loading point 20 while travelling in reverse, as indicated by arrow 26. A site at which guidance system 10 operates may include more than one loader 14.

Typically, each transport vehicle 12, after having been loaded with material by a loader 14 at a loading point 20, transports the material to an unloading point 22. The material is then unloaded from transport vehicle 12 at unloading point 22 (e.g., by tilting a container or bed of transport vehicle 12 that holds the loaded material). After unloading the material, transport vehicle 12 may travel back to loading point 20 to receive another load of material for removal to unloading point 22.

A route between loading point 20 and unloading point 22 may include a roadway 24. Roadway 24 may be constantly changing due to movement of transport vehicles 12 along roadway 24, various mining, dumping, construction, berm maintenance, or other activities on or adjacent to roadway 24.

Furthermore, obstacles 25 of various types may appear from time to time along roadway 24. An obstacle 25 may include, for example, material or debris that has fallen onto roadway 24, a person, equipment, a vehicle (e.g., that is not associated with guidance system 10), a pit, or another type of obstacle). One or more sensors of a vehicle unit 16 may detect an obstacle 25 and determine the location of the detected obstacle 25.

Each transport vehicle 12 that is connected to guidance system 10 includes a vehicle unit 16 of guidance system 10. Vehicle unit 16 includes one or more intercommunicating components that are associated with, e.g., mounted onto or incorporated into, transport vehicle 12. Components of vehicle unit 16 may be located, e.g., housed in a single housing, at a single location of transport vehicle 12, or may be mounted at different locations on transport vehicle 12. Vehicle units 16 that are associated with different transport vehicles 12 may communicate with one another.

In some cases, one or more loaders 14 each includes a loader unit 18 of guidance system 10. In other cases, a loader 14 may not include a loader unit 18 such that all functionality of guidance system 10 at a site may be provided by vehicle units 16.

In some cases, vehicle units 16, loader units 18, or both may be configured to communicate, typically wirelessly, with a controller 28. Controller 28 may receive data that is received from vehicle units 16 and any loader units 18 and store the data, e.g., in a database.

In some cases, controller 28 may be configured to generate and maintain and updated map of the site based on data that is received from vehicle units 16. The updated may be communicated to vehicle units 16. In other cases, the map may be updated by each vehicle unit 16, and shared with other vehicle units 16 at the site. As used herein, sharing of the map includes both sending a generated map to other vehicle units 16, and receiving generated maps from other vehicle units 16.

FIG. 1B is a schematic block diagram of an example of a vehicle unit of the guidance system illustrated in FIG. 1A.

Vehicle unit 16 includes sensors 30, including one or more sensor units. Sensors 30 are configured to sense a topography of an environment of transport vehicle 12. (As used herein, topography refers to the locations, and, in some cases, orientations, of surfaces that are detectable by sensors 30. The surfaces may be those of the terrain, or of manmade objects or structures. Topography may include identifiable features, e.g., key points or key object, whose locations are known relative to a local or global coordinate system.) For example, sensors 30 may detect topographic surfaces in the vicinity of transport vehicle 12. Topographic surfaces may include a surface of the ground or of a roadway 24, obstacles 25, safety berms, other transport vehicles 12, loader 18, or other surfaces. Sensors 30 may sense, e.g., the (angular) surface area, and the relative location and orientation of each region of a detected surface.

Typically, different sensor units of sensors 30 may be mounted at different locations on transport vehicle 12. For example, different sensor units of sensors 30 may be aimed at different sides or ends of transport vehicle 12 (e.g., some forward looking and some rearward looking). A sensor unit of sensors 30 may include, for example, a camera or optical imaging device (visible, infrared, or another spectral range; two-dimensional or three-dimensional, fixed or rotatable, fixed field of view or zoomable, or other type), a rangefinder (based on lidar, ultrasound, radar, or other technology; scannable or fixed), a GNSS receiver, an orientation sensor (e.g., compass or tilt sensor), environmental sensor (e.g., visibility or other environmental data), or other types of sensor units. A sensor unit of sensors 30 may sense one or more characteristics of transport vehicle 12 (e.g., speed of travel, direction of travel (e.g., forward or in reverse), steering angle,

Vehicle unit 16 includes a processor 32 and data storage 34.

Processor 32 may communicate with one or more other devices, such as another vehicle unit 16, loader unit 18, controller 28, or another device via communications module 36. Communications module 36 may include or communicate with one or more wireless transmitters or receivers capable of communicating data with sufficient speed to enable real-time communication of a current location, map updates, or other data.

Processor 32 may include one or more processing units, e.g. of one or more computers or other devices. Processor 32 is configured to operate in accordance with programmed instructions and various data inputs.

Data storage 34 may include one or more volatile or nonvolatile, fixed or removable, memory or data storage devices. Data storage 34 may include one or more remote devices that are in communication with vehicle unit 16 via communications module 36. Data storage 34 may be utilized to store, for example, programmed instructions for operation of processor 32, data or parameters for use by processor 32 during operation, or results of operation of processor 32.

Processor 32 may communicate with user interface 38. User interface 38 may include one or more visual output devices (e.g., display screens, indicator lights, or other visual output devices), one or more audible output devices (e.g., speakers, alarms, or other devices) for communicating audibly verbal or nonverbal information. User interface 38 may include one or more input devices for inputting data (e.g., an intended destination, labelling detected obstacles 25 or other detected objects that are not automatically identified, or other input data).

FIG. 1C is a schematic block diagram of a loader unit of the guidance system illustrated in FIG. 1A.

Loader unit 18 may include components (e.g., sensors 30, processor 32, data storage 34, communications module 36, and user interface 38) that are identical to corresponding components of a vehicle unit 16, or that may differ from those of vehicle unit 16. For example, sensors 30 that are relevant to operation of a transport vehicle 12 may be different from those that are relevant to operation of a loader 14. Similarly, programmed instructions for operation of a processor 32 of a vehicle unit 16 may be different from those for operation of a processor 32 of a loader unit 18.

In some cases, a loader unit 18 may include a marker unit 40 for marking a location of loading point 20. For example, marker unit 40 may include an infrared projector for projecting an infrared beam onto loading point 20 or onto one or more points at predetermined locations relative to loading point 20. The projected beam may then be detected by sensors 30 of vehicle unit 16 and may be utilized by vehicle unit 16 to direct transport vehicle 12 to loading point 20. For example, an infrared beam may be visible under dusty or other conditions where visibility of visible light is limited.

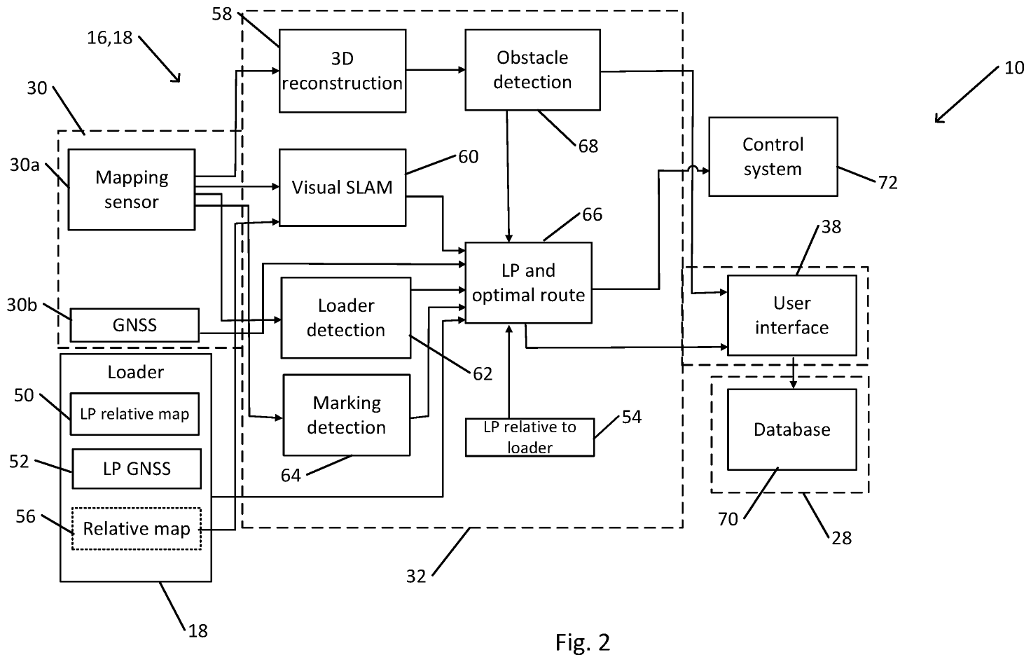

FIG. 2 is a schematic block diagram illustration an example of operation of the guidance system illustrated in FIG. 1A that is associated with a transport vehicle.

In the example shown, operations of calculation and analysis may be performed by processor 32 of either vehicle unit 16 or loader unit 18 Similarly, sensors 30 may be sensors of either vehicle unit 16 or of loader unit 18. For simplicity of the discussion of FIG. 2, processor 32 and sensors 30 are generally referred to as being those of vehicle unit 16. However, unless otherwise noted, the discussion is relevant also to operations based on sensors 30 and processor 32 of loader unit 18.

Loader unit 18 may calculate include or store information related to the location of loading point 20 relative to loader 14. For example, data storage 34 of loader unit 18 may store a map 50 of the location of loading point (LP) 20 relative to loader 14. An absolute location of loader 14 may be determined by a GNSS receiver 52 of sensors 30 of loader unit 18.

Sensors 30 of vehicle unit 16 may include GNSS receiver 30b and one or mapping sensors 30a. For example, mapping sensors 30a may include such devices as cameras configured to produce a three-dimensional image, lidar devices, or other devices that may be operated to produce a three-dimensional map of the topography of the environment of transport vehicle 12 (e.g., surfaces and objects in the vicinity of, e.g., having a direct line of sight to, mapping sensors 30a).

Data that is collected via mapping sensors 30a may be transmitted to a three dimensional (3D) reconstruction module 58 (e.g., a software module or dedicated hardware or firmware module) that runs on processor 32 of vehicle unit 16. The resulting three-dimensional map may be analyzed by obstacle detection module 68 to detect one or more obstacles 25. In some cases, three dimensional reconstruction module 58 may analyze data from mapping sensors 30a to identify one or more previously identified topographical features whose locations are know to determine a location of transport vehicle 12 relative to a predetermined coordinate system. In some cases, three dimensional reconstruction module 58 may analyze data from mapping sensors 30a to identify one or more features that are represented on a three-dimensional map that was received from another three-dimensional map, and to register the sensed features with the features on the received map.

Alternatively or in addition, (e.g., when processor 32 is of vehicle unit 16) data that is collected via mapping sensors 30a, as well as by GNSS receiver 30b, may be transmitted to visual SLAM module 60 to generate (e.g., create or update) a map of the region surrounding vehicle unit 16 and transport vehicle 12. Similarly, in some cases, a relative map 56 as constructed by loader unit 18 may be input to a visual SLAM module 60.

Loader detection module 62 may apply one or more image processing techniques to detect loader 14 in images that are acquired by one or more imaging sensors of mapping sensors 30a (e.g., when processor 32 is of vehicle unit 16). For example, an algorithm for identifying an image of loader 14 may be developed by one or more machine learning techniques, or otherwise. Similarly, a machine learning technique may be applied to identify a location of loading point 20 relative to loader 14 in acquired images. The location of loading point 20 relative to loader 14 as derived by images may be similarly developed by application of machine learning techniques.

When loader unit 18 includes a marker unit 40, marking detection module 64 may analyze image data that is acquired by one or more mapping sensors 30a (e.g., by infrared cameras or other types of sensors) to identify the marked location relative to transport vehicle 12 (e.g., when processor 32 is of vehicle unit 16).

Loading point and optimal route module 66 may calculate a location of loading point 20 relative to transport vehicle 12 and calculate an optimal route along which transport vehicle 12 is to be guided. The calculated route may also include a direction of approach of transport vehicle 12 (e.g., forward or in reverse) toward loading point 20. When guidance system 10 guides transport vehicle 12 along the optimal route, either by autonomous operation of transport vehicle 12 or by providing directions to a driver or operator of transport vehicle 12, transport vehicle 12 may arrive at the precise location of loading point 20 in a minimal time.

Loading point and optimal route module 66 may calculate the position of loading point 20 and the optimal route based on input from one or more modules of vehicle unit 16 and of loader unit 18. For example, input to loading point and optimal route module 66 may include output from one or more of visual SLAM module 60, GNSS receiver 30b, loader detection module 62, marking detection module 64, obstacle detection module 68 (e.g., in planning a route that avoids any detected obstacles 18), modules or data from loader unit 18, and loading point relative to loader module 54.

The calculated location of loading point 20 and of the optimal route may be communicated to a driver or operator of transport vehicle 12 in one or more manners via user interface 38. Any obstacles 25 that are identified by obstacle detection module 68 may also be communicated to user interface 38.

For example, the calculated route, including any obstacle 25 that is to be avoided, may be displayed as a map showing the locations of transport vehicle 12 and loading point 20. In another example, the location of loading point 20 and any obstacles 25 may be superposed on a current image of the vicinity of transport vehicle 12 that is acquired by a camera of sensors 30. In another example, instructions for driving transport vehicle 12 to loading point 20, e.g., while avoiding any obstacles 25, may be conveyed visually, audibly, or both.

In some cases, a log or record of operation of transport vehicle 12 as guided by guidance system 10 and vehicle unit 16 may be transmitted to controller 28, e.g., for storage in database 70.

In some cases, output from loading point and optimal route module 66 (e.g., the calculated optimal route and locations of any obstacles 25), a record of operation of transport vehicle 12, or both may be transmitted via an internal communications channel (e.g., cable or optical fiber) of transport vehicle 12 (or via communications module 36) to control system 72. For example, control system 72 may be incorporated into an autonomously operable transport vehicle 12. Control system 72 may analyze the transmitted data and generate programmed instructions for autonomous operation of transport vehicle 12.

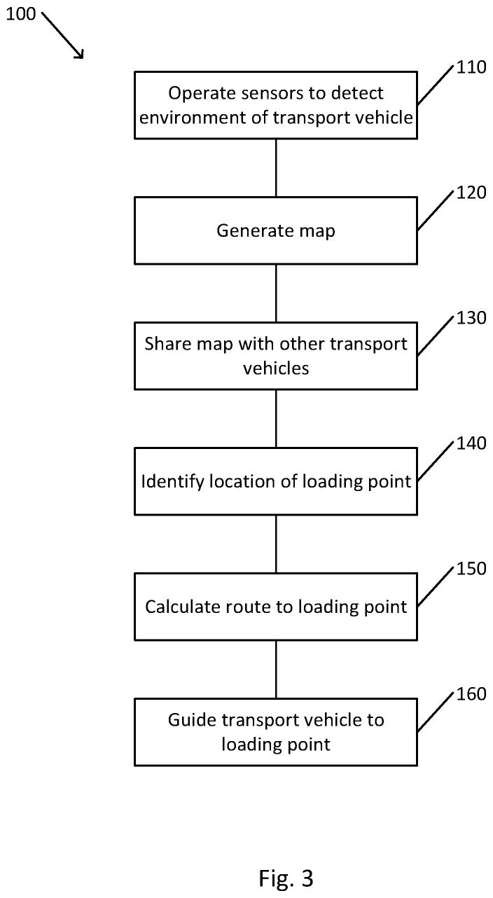

FIG. 3 is a flow chart depicting a method of operation of the guidance system that is illustrated in FIG. 1A.

Execution of guidance method 100 is intended to efficiently guide a transport vehicle 12 that is associated with guidance system 10 (e.g., that is equipped with a vehicle unit 16) directly and precisely to a loading point 20, as rapidly as possible and with as few course corrections as possible.

Operations of guidance method 100 may be executed by one or more processors of guidance system 10. The processors may include one or more of a processor 32 of vehicle unit 16 or loader unit 18, or controller 28. Guidance method 10 may be executed continuously during operation of vehicle unit 16 or of other components of guidance system 10, or may be initiated by an operator of a transport vehicle 12 that is equipped with vehicle unit 16.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Although operations of guidance method 100 are described, for simplicity of the discussion, as being executed by components of a vehicle unit 16, the operations may be executed by a loader unit 18. Reference to components of vehicle unit 16 in the discussion of FIG. 3 may be replaced by components of loader unit 18, unless otherwise noted.

Vehicle unit 16 of a transport vehicle 12 may operate one or more sensors 30, e.g., mapping sensors 30a, to sense the topography of an environment of transport vehicle 12 (block 110). For example, the operated sensor 30 may detect the location and orientation in three dimensions of surfaces and objects that are near (e.g., detectable by surfaces of vehicle unit 16 installed on) transport vehicle 12 (or near loader 14).

Processor 32 of transport vehicle 12, e.g., visual SLAM module 60 operating on processor 32, may generate a map of a site within which transport vehicle 12 operates (block 120). Generation of the map may include creating a new map or modifying a previously created and shared map. A previously created map may have been stored in data storage 34 of vehicle unit 16, or may be stored elsewhere (e.g., in data storage 34 of a vehicle unit 16 of another transport vehicle 12, on controller 28, or elsewhere within guidance system 10).

The generated map may be shared with other vehicle units 16 on other transport vehicles 12 (block 130). For example, communications module 36 of one vehicle unit 16 may transmit the map, or modifications of the map, to other vehicle units 16, either directly or via controller 28. Similarly, communications module 36 of one vehicle unit 16 may receive the map, or modifications of the map, from other vehicle units 16, either directly or via controller 28. Each vehicle unit 16 that receives the map or modifications may store the updated map.

Vehicle unit 16 may utilize the map, and, some cases, other data, to identify the location of loading point 20 relative to transport vehicle 12 (block 140). For example, loading point and optimal route module 66, operating on processor 32 of vehicle unit 16, may utilize a map generated by visual SLAM module 60, together with information related to loader 14 (e.g., from one or more of loader detection module 62, loading point relative to loader module 54, and marking detection module 64) to determine a location of loading point 20 relative to transport vehicle 12.

Loading point and optimal route module 66 may then calculate a route from a current location of transport vehicle 12 to loading point 20 (block 150). The calculated route may take into account any obstacles 25 that were identified. The calculated route may also include a direction of approach of transport vehicle 12 (e.g., forward or in reverse) toward loading point 20 at each point along the calculated route.

The calculated route then may be transmitted to user interface 38 of vehicle unit 16, or to a control system 72 of transport vehicle 12, to guide transport vehicle 12 to loading point 20 (block 160). For example, user interface 38 may continually convey (e.g., visually, audibly, or both) instructions to a driver or operator of transport vehicle 12 as transport vehicle 12 travels toward loading point 20. Alternatively or in addition, control system 72 may autonomously operate transport vehicle 12 to bring transport vehicle 12 to loading point 20.

In the event that an obstacle 25 is detected (e.g., an obstacle 25 that was not incorporated into the map) while travelling toward loading point 20, the location of that obstacle 25 may be shared with other vehicle units 16 and the map may be updated.

In some cases, a machine learning module of processor 32 may operate during travel toward loading point 20, e.g., to improve an algorithm for calculating an optimal route, or otherwise.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A vehicle onboard guidance system comprising:
a guidance unit comprising:
a communications module; and
a processor configured to:
receive from one or more sensors sensed data of at least a topography of an environment of a vehicle on which the guidance unit is installed;
analyze the sensed data to perform one or more of:
generate a map of the environment based on the received sensed data and share, via the communications module, the generated map with another vehicle onboard guidance system;
register the topography with a map of the environment that was received, via the communications module, from another vehicle onboard guidance system; and
generate an updated map by modifying a map of the environment that was received, via the communications module, from another vehicle onboard guidance system.

2. The system of claim 1, wherein the processor is further configured to calculate, based on the map, a route of a transport vehicle to a loading point where a load is to be loaded onto the transport vehicle by a loader.

3. The system of claim 2, wherein the vehicle on which the guidance unit is installed is the transport vehicle or the loader.

4. The system of claim 2, wherein the calculated route comprises an approach direction of the transport vehicle to the loading point.

5. The system of claim 2, wherein the processor is further configured to guide the transport vehicle along the calculated route to the loading point.

6. The system of claim 5, wherein the processor is configured to guide the transport vehicle by communicating with a control system that is configured to autonomously control the transport vehicle.

7. The system of claim 1, further comprising said one or more sensors.

8. The system of claim 7, wherein said one or more sensors is configured to sense a marker that marks the location of a loading point where a load is to be loaded onto the transport vehicle by a loader.

9. The system of claim 8, wherein the marker comprises a beam that is projected by the loader onto the loading point.

10. The system of claim 9, wherein the beam comprises infrared radiation.

11. The system of claim 7, wherein said one or more sensors comprises an imaging sensor.

12. The system of claim 11, wherein the processor is configured to identify an image of the loader and a position of the loading point relative to the loader in an image that is acquired by the imaging sensor.

13. The system of claim 1, wherein the processor is configured to share, via the communications module, the updated map with another vehicle onboard guidance system.

14. A guidance method comprising:
receiving, by a processor of a vehicle onboard guidance system from one or more sensors, sensed data of at least a topography of an environment of a vehicle on which the guidance unit is installed;
analyzing, by the processor, the sensed data to perform one or more of:
generating a map of the environment based on the received sensed data and share, via the communication module, the generated map with another vehicle onboard guidance system;
registering the topography with a map of the environment that was received, via the communication module, from another vehicle onboard guidance system; and
generating an updated map by modifying a map of the environment that was received, via the communications module, from another vehicle onboard guidance system.

15. The method of claim 14, further comprising calculating, by the processor, based on the map, a route of a transport vehicle to a loading point where a load is to be loaded onto the transport vehicle by a loader.

16. The method of claim 15, wherein the processor that calculates the route is installed on the transport vehicle or on the loader.

17. The method of claim 15, further comprising identifying, by the processor, an obstacle, wherein calculating the route comprises calculating a route that avoids the obstacle.

18. The method of claim 15, further comprising guiding the transport vehicle to the loading point.

19. The method of claim 18, wherein guiding the transport vehicle comprises transmitting the calculated route to a control system that is configured to autonomously operate the transport vehicle.

20. The method of claim 18, wherein guiding the transport vehicle comprises operating a user interface to convey instructions for travelling along the calculated route to an operator of the transport vehicle.

21. A method comprising
providing to each of a plurality of vehicles operating at a site a vehicle onboard guidance system comprising:
a guidance unit comprising:
a communication module; and
a processor configured to:
receive from one or more sensors sensed data of at least a topography of an environment of a vehicle on which the guidance unit is installed;
analyze the sensed data to perform one or more of:
generate a map of the environment based on the received sensed data and share, via the communication module, the generated map with another vehicle onboard guidance system;
register the topography with a map of the environment that was received, via the communication module, from another vehicle onboard guidance system; and
generate an updated map by modifying a map of the environment that was received, via the communications module, from another vehicle onboard guidance system.
